(19) United States
(12) Patent Application Publication
(10) Pub. No.: US 2025/0003099 A1
(43) Pub. Date: Jan. 2, 2025

(54) ELECTROLYSIS OF Li2SO4 AT LOW PH RANGES

(71) Applicant: BASF SE, Ludwigshafen am Rhein (DE)

(72) Inventors: Nils-Olof Joachim Born, Ludwigshafen (DE); Arnd Garsuch, Ludwigshafen (DE); Kerstin Schierle-Arndt, Ludwigshafen (DE); Wolfram Wilk, Ludwigshafen (DE); Sigmar Braeuninger, Ludwigshafen (DE); Regina Vogelsang, Ludwigshagen (DE); Bastian Opitz, Ludwigshafen (DE); Daniel Malko, Ludwigshafen (DE); Vincent Smith, Midrand (ZA)

(73) Assignee: BASF SE, Ludwigshafen am Rhein (DE)

(21) Appl. No.: 18/576,396

(22) PCT Filed: Jul. 7, 2022
(86) PCT No.: PCT/EP2022/069014

§ 371 Date: Jan. 4, 2024

Related U.S. Application Data
(60) Provisional application No. 63/220,259, filed on Jul. 9, 2021.

(51) Int. Cl. C25C 1/02; C22B 26/12; H01M 10/54

(52) U.S. Cl. CPC C25C 1/02; C22B 26/12; H01M 10/54

(57) ABSTRACT

Disclosed herein are processes comprising electrolyzing an aqueous solution comprising lithium, wherein the aqueous solution has a pH less than 0.5. Also disclosed are processes comprising electrolyzing a first aqueous solution comprising lithium to obtain a second aqueous solution comprising lithium, and an acidic aqueous solution having a pH less than 0.5, adjusting the pH of the second aqueous solution with the acidic aqueous solution to obtain a third aqueous solution comprising lithium having a pH less than 0.5, and electrolyzing the third aqueous solution comprising lithium. Additionally disclosed are, processes comprising stripping a liquid medium comprising lithium with an acidic aqueous solution to obtain an aqueous solution comprising lithium, and electrolyzing the aqueous solution comprising lithium. Further disclosed are processes for preparing a liquid medium comprising lithium.

### FIELD OF THE INVENTION

Disclosed herein are processes comprising electrolyzing an aqueous solution comprising lithium, wherein the aqueous solution has a pH less than 0.5. Also disclosed are processes comprising electrolyzing a first aqueous solution comprising lithium to obtain a second aqueous solution comprising lithium, and an acidic aqueous solution having a pH less than 0.5, adjusting the pH of the second aqueous solution with the acidic aqueous solution to obtain a third aqueous solution comprising lithium having a pH less than 0.5, and electrolyzing the third aqueous solution comprising lithium. Additionally disclosed are processes comprising stripping a liquid medium comprising lithium with an acidic aqueous solution to obtain an aqueous solution comprising lithium, and electrolyzing the aqueous solution comprising lithium. Further disclosed are processes for preparing a liquid medium comprising lithium.

### BACKGROUND

High purity lithium is a valuable resource. Many sources of lithium, such as lithium ion batteries, lithium ion battery waste, lithium containing water, e.g. ground water, and raw lithium containing ores, are complex mixtures of various elements and compounds. It may be desirable to remove various non-lithium impurities to obtain high purity lithium. Electrolysis of an aqueous solution comprising lithium provides an exemplary means for obtaining high purity lithium. In some electrolysis processes, the current density may be limited by the pH of the aqueous solution. In some electrolysis processes, the pH may be adjusted by, e.g., adding a base to the aqueous solution comprising lithium. Adding a base may, however, form an undesirable salt and generate undesirable solid particles. Such particles may be difficult to remove, and may result in a more expensive purification process. Additionally, in some lithium purification processes, a stripping step is used to transfer lithium from a liquid medium to an aqueous solution prior to electrolysis. In some such processes, fresh acid, such as H2SO4, is added as a stripping agent.

Accordingly, there is a need for economic processes with high lithium recovery and high lithium purity. There is a need for improved electrolysis performance. There is also a need for economical generation and use of stripping agents such as H2SO4. In some embodiments, it may be desirable to perform electrolysis at different pH levels. In some embodiments, it may be desirable to avoid adjusting the pH level before performing the electrolysis. In some embodiments, it may be desirable to generate lithium from solutions that already have a low pH level.

### SUMMARY OF THE INVENTION

Disclosed herein are processes comprising electrolyzing an aqueous solution comprising lithium, wherein the aqueous solution has a pH less than 0.5. In some embodiments, the aqueous solution comprises sulfate. In some embodiments, the pH of the aqueous solution is adjusted along a gradient ranging from −1 to 0.5. In some embodiments, the pH of the aqueous solution is adjusted up along a gradient ranging from −1 to 0.5. In some embodiments, the pH of the aqueous solution is adjusted down along a gradient ranging from −1 to 0.5. In some embodiments, a process comprises electrolyzing a first aqueous solution comprising lithium to obtain a second aqueous solution comprising lithium, and an acidic aqueous solution having a pH less than 0.5, adjusting the pH of the second aqueous solution with the acidic aqueous solution to obtain a third aqueous solution comprising lithium having a pH less than 0.5, and electrolyzing the third aqueous solution. In some embodiments, the first aqueous solution has a pH greater than 0.5. In some embodiments, electrolyzing the first aqueous solution is performed in a different electrolysis cell than electrolyzing the third aqueous solution. In some embodiments, a process comprises stripping a liquid medium comprising lithium with an acidic aqueous solution to obtain an aqueous solution comprising lithium, and electrolyzing the aqueous solution comprising lithium to obtain a lithium-depleted aqueous solution; wherein the lithium-depleted aqueous solution is provided upstream in the process as the acidic aqueous solution, wherein the liquid medium comprises less than 50 weight % water by total weight of the liquid medium, and wherein the lithium-depleted aqueous solution has a lower concentration of lithium than the aqueous solution comprising lithium. In some embodiments, the lithium-depleted aqueous solution has a concentration of lithium greater than zero. In some embodiments, the liquid medium comprises less than 5 weight % of water by total weight of the liquid medium. In some embodiments, the lithium-depleted aqueous solution has a concentration of lithium ranging from about 20 g/L to about 100 g/L. In some embodiments, the aqueous solution comprising lithium has a concentration of lithium ranging from about 20 g/L to about 100 g/L.] In some embodiments, a process for preparing a liquid medium comprising lithium comprises electrolyzing an aqueous solution comprising lithium at a pH less than 0.5 to obtain a lithium-depleted aqueous solution, and extracting the lithium-depleted aqueous solution with a liquid medium; wherein the liquid medium comprises less than 50 weight % of water by total weight of the liquid medium, and wherein the lithium-depleted aqueous solution has a lower concentration of lithium than the aqueous solution comprising lithium.

### BRIEF DESCRIPTION OF THE DRAWINGS

FIG. 1 depicts an exemplary electrolysis cell.

FIG. 2 depicts an exemplary process consistent with some embodiments of the disclosure.

### DEFINITIONS

As used herein, “a” or “an” entity refers to one or more of that entity, e.g., “a compound” refers to one or more compounds or at least one compound unless stated otherwise. As such, the terms “a” (or “an”), “one or more”, and “at least one” are used interchangeably herein.

As used herein, the term “material” refers to the elements, constituents, and/or substances of which something is composed or can be made.

As used herein, the term “about” refers to a ±5% of the stated number. Unless otherwise stated, all numbers are assumed to be modified by “about”.

As used herein, the term “electrolysis” refers to the chemical decomposition produced by passing an electric current through a liquid or solution comprising ions.

### DETAILED DESCRIPTION OF THE DRAWINGS

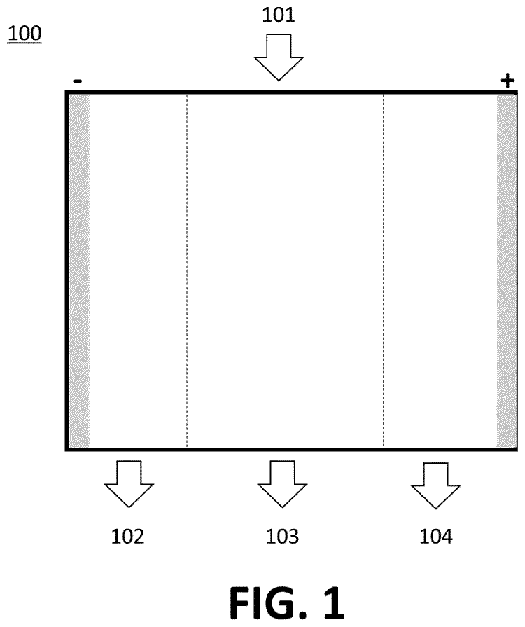

FIG. 1 depicts an exemplary electrolysis cell (100). An aqueous solution comprising lithium (101) may be supplied to the electrolysis cell (100). In some embodiments, the aqueous solution comprising lithium is obtained by a process comprising: mechanically comminuting at least one chosen from a lithium ion battery, lithium ion battery waste, lithium ion battery production scrap, lithium ion cell production scrap, lithium ion cathode active material, and combinations thereof to obtain a black mass, and leaching the black mass to obtain an aqueous solution comprising lithium. In some embodiments, the aqueous solution comprising lithium is obtained by leaching a lithium containing ore. In some embodiments, the aqueous solution comprising lithium is lithium containing ground water. In some embodiments, the aqueous solution comprising lithium is obtained by leaching a battery material. In some electrolysis cells, such as the exemplary cell depicted in FIG. 1, there may be one or more membranes. FIG. 1 depicts two such membranes as vertical dashed lines. Positive ions, such as Li+, tend to migrate towards the negatively charged electrode whereas negative ions, such as SO42−, tend to migrate towards the positively charged electrode. During electrolysis, basic hydroxide ions may form near the negative electrode and may increase the local pH. During electrolysis, acidic protons may form near the positive electrode and may decrease the local pH. A lithium-enriched and/or more basic aqueous solution may be obtained near the negative electrode (102). A lithium-depleted and/or more acid aqueous solution may be obtained near the positive electrode (104). A lithium-depleted and/or more acid aqueous solution, lithium-enriched and/or more basic aqueous, or an aqueous solution having substantially the same lithium concentration and/or pH may also be obtained (103). Here, enriched, depleted, more basic, and more acidic, each refer to properties of the aqueous solution relative to the supplied aqueous solution comprising lithium (101).

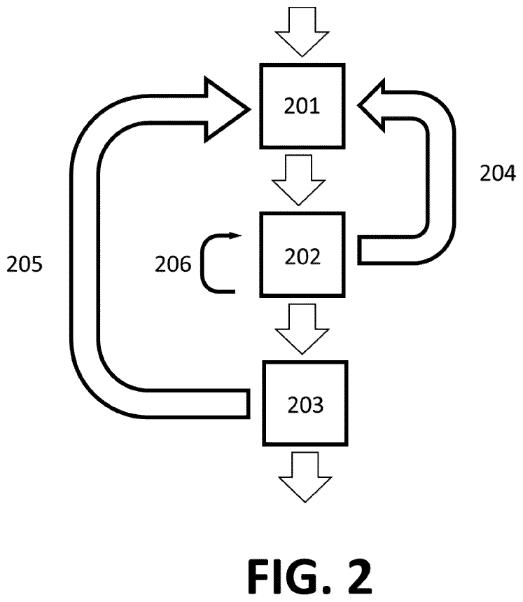

FIG. 2 depicts an exemplary process consistent with some embodiments of the disclosure. A liquid medium comprising lithium may be stripped with an acidic aqueous solution to obtain an aqueous solution comprising lithium (201). An aqueous solution comprising lithium may be a first aqueous solution comprising lithium and may be electrolyzed (202) to obtain a second aqueous solution comprising lithium, and an acidic aqueous solution having a pH less than 0.5;the pH of the second aqueous solution may be adjusted with the acidic aqueous solution to obtain a third aqueous solution comprising lithium having a pH less than 0.5 (206); and the third aqueous solution comprising lithium may be electrolyzed (202). The electrolysis step or steps (202) may be performed in one or more electrolysis cells and may be performed one or more times. An aqueous solution comprising lithium may be electrolyzed (202) to obtain a lithium-depleted aqueous solution which may be provided upstream in the process (204) as the acidic aqueous solution in a stripping step (201). A lithium-depleted aqueous solution may be extracted with a liquid medium to obtain a liquid medium comprising lithium (203). The liquid medium comprising lithium may be provided upstream in a process (205) to a stripping step (201). Each of the stripping (201), electrolyzing (202), and extracting (203) steps may be performed independently with or without each or any of the depicted steps, may be performed in any order, may be performed one or more times, and may be performed with or without providing each or any of the various fluids obtained by each of the stripping (201), electrolyzing (202), and extracting (203) steps upstream (204), (205), and (206).

### DETAILED DESCRIPTION

For example, disclosed herein are processes comprising electrolyzing an aqueous solution comprising lithium, wherein the aqueous solution has a pH less than 0.5. In some embodiments, the processes comprise electrolyzing an aqueous solution comprising lithium, wherein the aqueous solution has a pH less than 0.4. In some embodiments, the processes comprise electrolyzing an aqueous solution comprising lithium, wherein the aqueous solution has a pH less than 0.3. In some embodiments, the processes comprise electrolyzing an aqueous solution comprising lithium, wherein the aqueous solution has a pH less than 0.2. In some embodiments, the processes comprise electrolyzing an aqueous solution comprising lithium, wherein the aqueous solution has a pH less than 0.1. In some embodiments, the processes comprise electrolyzing an aqueous solution comprising lithium, wherein the aqueous solution has a pH less than 0. In some embodiments, the processes comprise electrolyzing an aqueous solution comprising lithium, wherein the aqueous solution has a pH ranging from −1 to 0.5. In some embodiments, the processes comprise electrolyzing an aqueous solution comprising lithium, wherein the aqueous solution has a pH ranging from 0 to 0.5. In some embodiments, the processes comprise electrolyzing an aqueous solution comprising lithium, wherein the aqueous solution has a pH ranging from 0 to 0.4. In some embodiments, the processes comprise electrolyzing an aqueous solution comprising lithium, wherein the aqueous solution has a pH ranging from 0 to 0.3. In some embodiments, the processes comprise electrolyzing an aqueous solution comprising lithium, wherein the aqueous solution has a pH ranging from 0 to 0.2. In some embodiments, the processes comprise electrolyzing an aqueous solution comprising lithium, wherein the aqueous solution has a pH ranging from 0 to 0.1.

In some embodiments, the aqueous solution comprises sulfate.

In some embodiments, the pH of the aqueous solution is adjusted along a gradient ranging from −1 to 0.5. In some embodiments, the pH of the aqueous solution is adjusted up and/or down along a gradient ranging from −1 to 0.5. In some embodiments, the pH of the aqueous solution is adjusted along a gradient ranging from 0 to 0.5.

In some embodiments, the pH of the aqueous solution is adjusted up along a gradient ranging from −1 to 0.5. In some embodiments, the pH of the aqueous solution is adjusted up along a gradient ranging from 0 to 0.5. In some embodiments, the pH of the aqueous solution is adjusted up along a gradient ranging from 0 to 0.5 by adding a base.

In some embodiments, the pH of the aqueous solution is adjusted down along a gradient ranging from −1 to 0.5. In some embodiments, the pH of the aqueous solution is adjusted down along a gradient ranging from 0 to 0.5. In some embodiments, the pH of the aqueous solution is adjusted down along a gradient ranging from 0 to 0.5 by adding an acid.

In some embodiments, a process comprises electrolyzing a first aqueous solution comprising lithium to obtain a second aqueous solution comprising lithium, and an acidic aqueous solution having a pH less than 0.5, adjusting the pH of the second aqueous solution with the acidic aqueous solution to obtain a third aqueous solution comprising lithium having a pH less than 0.5, and electrolyzing the third aqueous solution.

In some embodiments, the first aqueous solution has a pH greater than 0.5.

In some embodiments, electrolyzing the first aqueous solution is performed in a different electrolysis cell than electrolyzing the third aqueous solution.

In some embodiments, a process comprises stripping a liquid medium comprising lithium with an acidic aqueous solution to obtain an aqueous solution comprising lithium, and electrolyzing the aqueous solution comprising lithium to obtain a lithium-depleted aqueous solution; wherein the lithium-depleted aqueous solution is provided upstream in the process as the acidic aqueous solution, wherein the liquid medium comprises less than 50 weight % water by total weight of the liquid medium, and wherein the lithium-depleted aqueous solution has a lower concentration of lithium than the aqueous solution comprising lithium.

In some embodiments, the lithium-depleted aqueous solution has a concentration of lithium greater than zero.

In some embodiments, the liquid medium comprises less than 5 weight % of water by total weight of the liquid medium. In some embodiments, the liquid medium comprises less than 10 weight % of water by total weight of the liquid medium. In some embodiments, the liquid medium comprises less than 20 weight % of water by total weight of the liquid medium. In some embodiments, the liquid medium comprises less than 1 weight % of water by total weight of the liquid medium. In some embodiments, the liquid medium comprises less than 0.1 weight % of water by total weight of the liquid medium. In some embodiments, the liquid medium is immiscible with water. In some embodiments, the liquid medium is an organic solvent. In some embodiments, the liquid medium comprises at least one chelating agent for lithium.

In some embodiments, the lithium-depleted aqueous solution has a concentration of lithium ranging from about 20 g/L to about 100 g/L. In some embodiments, the lithium-depleted aqueous solution has a concentration of lithium ranging from about 30 g/L to about 100 g/L. In some embodiments, the lithium-depleted aqueous solution has a concentration of lithium ranging from about 40 g/L to about 100 g/L. In some embodiments, the lithium-depleted aqueous solution has a concentration of lithium ranging from about 50 g/L to about 100 g/L. In some embodiments, the lithium-depleted aqueous solution has a concentration of lithium ranging from about 60 g/L to about 100 g/L. In some embodiments, the lithium-depleted aqueous solution has a concentration of lithium ranging from about 70 g/L to about 100 g/L. In some embodiments, the lithium-depleted aqueous solution has a concentration of lithium ranging from about 80 g/L to about 100 g/L. In some embodiments, the lithium-depleted aqueous solution has a concentration of lithium ranging from about 90 g/L to about 100 g/L. In some embodiments, the lithium-depleted aqueous solution has a concentration of lithium ranging from about 20 g/L to about 90 g/L. In some embodiments, the lithium-depleted aqueous solution has a concentration of lithium ranging from about 20 g/L to about 80 g/L. In some embodiments, the lithium-depleted aqueous solution has a concentration of lithium ranging from about 20 g/L to about 70 g/L. In some embodiments, the lithium-depleted aqueous solution has a concentration of lithium ranging from about 20 g/L to about 60 g/L. In some embodiments, the lithium-depleted aqueous solution has a concentration of lithium ranging from about 20 g/L to about 50 g/L. In some embodiments, the lithium-depleted aqueous solution has a concentration of lithium ranging from about 20 g/L to about 40 g/L. In some embodiments, the lithium-depleted aqueous solution has a concentration of lithium ranging from about 20 g/L to about 30 g/L. In some embodiments, the lithium-depleted aqueous solution has a concentration of lithium ranging from about 30 g/L to about 90 g/L. In some embodiments, the lithium-depleted aqueous solution has a concentration of lithium ranging from about 40 g/L to about 80 g/L. In some embodiments, the lithium-depleted aqueous solution has a concentration of lithium ranging from about 50 g/L to about 70 g/L.

In some embodiments, the aqueous solution comprising lithium has a concentration of lithium ranging from about 20 g/L to about 100 g/L. In some embodiments, the aqueous solution comprising lithium has a concentration of lithium ranging from about 30 g/L to about 100 g/L. In some embodiments, the aqueous solution comprising lithium has a concentration of lithium ranging from about 40 g/L to about 100 g/L. In some embodiments, the aqueous solution comprising lithium has a concentration of lithium ranging from about 50 g/L to about 100 g/L. In some embodiments, the aqueous solution comprising lithium has a concentration of lithium ranging from about 60 g/L to about 100 g/L. In some embodiments, the aqueous solution comprising lithium has a concentration of lithium ranging from about 70 g/L to about 100 g/L. In some embodiments, the aqueous solution comprising lithium has a concentration of lithium ranging from about 80 g/L to about 100 g/L. In some embodiments, the aqueous solution comprising lithium has a concentration of lithium ranging from about 90 g/L to about 100 g/L. In some embodiments, the aqueous solution comprising lithium has a concentration of lithium ranging from about 20 g/L to about 90 g/L. In some embodiments, the aqueous solution comprising lithium has a concentration of lithium ranging from about 20 g/L to about 80 g/L. In some embodiments, the aqueous solution comprising lithium has a concentration of lithium ranging from about 20 g/L to about 70 g/L. In some embodiments, the aqueous solution comprising lithium has a concentration of lithium ranging from about 20 g/L to about 60 g/L. In some embodiments, the aqueous solution comprising lithium has a concentration of lithium ranging from about 20 g/L to about 50 g/L. In some embodiments, the aqueous solution comprising lithium has a concentration of lithium ranging from about 20 g/L to about 40 g/L. In some embodiments, the aqueous solution comprising lithium has a concentration of lithium ranging from about 20 g/L to about 30 g/L. In some embodiments, the aqueous solution comprising lithium has a concentration of lithium ranging from about 30 g/L to about 90 g/L. In some embodiments, the aqueous solution comprising lithium has a concentration of lithium ranging from about 40 g/L to about 80 g/L. In some embodiments, the aqueous solution comprising lithium has a concentration of lithium ranging from about 50 g/L to about 70 g/L.

In some embodiments, a process for preparing a liquid medium comprising lithium comprises electrolyzing an aqueous solution comprising lithium at a pH less than 0.5 to obtain a lithium-depleted aqueous solution, and extracting the lithium-depleted aqueous solution with a liquid medium; wherein the liquid medium comprises less than 50 weight % of water by total weight of the liquid medium, and wherein the lithium-depleted aqueous solution has a lower concentration of lithium than the aqueous solution comprising lithium.

In some embodiments, an electrolysis cell comprises at least one membrane. In some embodiments, an electrolysis cell comprises at least two membranes. In some embodiments, an electrolysis cell comprises two membranes. The membranes may be any known lithium ion conducting membrane for use in electrolysis of an aqueous solution comprising lithium. In some embodiments, the at least one membrane is chosen from a ceramic membrane, a polymer membrane, and combinations thereof. In some embodiments, a polymer membrane is a sulfonated membrane. In some embodiments, a sulfonated membrane has a hydrocarbon backbone or a PTFE backbone. In some embodiments, a sulfonated membrane is a sulfonated polyaryleneether or a polyphenylsulfon e.g. a polyaryleneether Ultrason® or polyphenylsulfon Ultrason®. In some embodiments, a polymer membrane is at least one chosen from a perfluorinated membrane, a cation exchange membrane, a PEEK-reinformed membrane, a styrene/divinylbenzene membrane, and combinations thereof. In some embodiments, a membrane is a fluorinated copolymer with sulfonic acid groups. In some embodiments, a membrane is a perfluorosulfonate polymer membrane. In some embodiments, the perfluorosulfonate polymer membrane is NAFION by E.I. du Pont de Nemours.

An electro chemical cell comprises a cathode and an anode. An exemplary electro chemical cell is ICI FM01. In some embodiments, a cell may be configured in a monopolar or bipolar configuration. The cathode may be any cathode known for electrolysis of an aqueous solution comprising lithium. The anode may be any anode known for electrolysis of an aqueous solution comprising lithium. In some embodiments, an anode is at least one chosen from a metal electrode, a metal oxide electrode, an electrode coated with a platinum group metal, and an electrode coated a platinum group metal oxide. In some embodiments, the thickness of the coating on the anode ranges from 1 micron to 100 microns. In some embodiments, the anode is titanium. In some embodiments, an anode has a geometry chosen from a mesh, a plate, a wire, a foam, and a felt. In some embodiments, an anode is a sheet, a rod, flat, corrugated, rectangular, unsymmetrical, or combinations thereof. In some embodiments, an anode has iridium oxide coated on a titanium substrate. In some embodiments, an anode comprises an electrically conductive substrate with a surface coating of metal oxide doped with at least one precious metal. In some embodiments, the metal oxide is chosen from titanium, tantalum, niobium, zirconium, and combinations thereof. In some embodiments, the precious metal is chosen from platinum, ruthenium, palladium, iridium, rhodium, osmium, and combinations thereof. In some embodiments, a cathode is at least one chosen from a metal electrode, a metal oxide electrode, an electrode with a platinum group metal, and an electrode coated a platinum group metal oxide. In some embodiments, the thickness of the coating on the cathode ranges from 1 micron to 100 microns. In some embodiments, a cathode is at least one chosen from a nickel electrode and a stainless steel electrode. In some embodiments, a cathode has a geometry chosen from a mesh, a plate, a wire, a foam, and a felt.

In some embodiments, a cathode is a sheet, a rod, flat, corrugated, rectangular, unsymmetrical, or combinations thereof. In some embodiments, a cathode is a stainless steel electrode. In some embodiments, a cathode is chosen from a porous metal. In some embodiments, a cathode comprises stainless steel, nickel, cobalt, titanium, steel, lead, platinum, and combinations thereof.

In some embodiments, at least one, at least two, at least 10, at least 100, at least 500 electrolysis cells are stacked one after another in fluid communication. A stack of electrolysis cells has an inlet and an outlet. In some embodiments, a process comprises electrolyzing an aqueous solution comprising lithium in a stack of electrolysis cells having a pH gradient from inlet to outlet. In some embodiments, a process comprises electrolyzing an aqueous solution comprising lithium in a stack of electrolysis cells having a decreasing pH gradient from inlet to outlet. In some embodiments, a process comprises electrolyzing an aqueous solution comprising lithium in a stack of electrolysis cells having a decreasing pH gradient from inlet to outlet, wherein the inlet has a pH greater than 0.5 and the outlet has a pH less than 0.5. In some embodiments, a process comprises electrolyzing an aqueous solution comprising lithium in a stack of electrolysis cells having a decreasing pH gradient from inlet to outlet, wherein the inlet has a pH greater than 0.5 and the outlet has a pH less than 0.5 and wherein the stack comprises at least 100electrolysis cells serially connected in fluid communication.

### Black Mass

“Black mass” refers to materials comprising lithium derived from, for example, a lithium ion battery, lithium ion battery waste, lithium ion battery production scrap, lithium ion cell production scrap, lithium ion cathode active material, and/or combinations thereof by mechanical processes such as mechanical comminution. For example, black mass may be derived from battery scrap by mechanically treating the battery scrap to obtain the active components of the electrodes such as graphite and cathode active material and may include impurities from the casing, electrode foils, cables, separator, and electrolyte. In some examples, the battery scrap may be subjected to a heat treatment to pyrolyze organic (e.g., electrolyte) and polymeric (e.g., separator and binder) materials. Such a heat treatment may be performed before or after mechanical comminution of the battery material.

Lithium ion batteries may be disassembled, punched, milled, for example in a hammer mill, and/or shredded, for example in an industrial shredder. From this kind of mechanical processing the active material of the battery electrodes may be obtained. A light fraction such as housing parts made from organic plastics and aluminum foil or copper foil may be removed, for example, in a forced stream of gas, air separation or classification.

Battery scraps may stem from, e.g., used batteries or from production waste such as off-spec material. In some embodiments a battery material is obtained from mechanically treated battery scraps, for example from battery scraps treated in a hammer mill or in an industrial shredder. Such material may have an average particle diameter (D50) ranging from 1 μm to 1 cm, such as from 1 to 500 μm, and further for example, from 3 to 250 μm.

Larger parts of the battery scrap like the housings, the wiring and the electrode carrier films may be separated mechanically such that the corresponding materials may be excluded from the battery material that is employed in the process.

Mechanically treated battery scrap may be subjected to a solvent treatment in order to dissolve and separate polymeric binders used to bind the transition metal oxides to current collector films, or, e.g., to bind graphite to current collector films. Suitable solvents are N-methylpyrrolidone, N,N-dimethylformamide, N,N-dimethylacetamide, N-ethylpyrrolidone, and dimethylsulfoxide, in pure form, as mixtures of at least two of the foregoing, or as a mixture with 1% to 99% by weight of water.

Mechanically treated battery scrap may be subjected to a heat treatment in a wide range of temperatures under different atmospheres. The temperature range is usually in the range of 100° C. to 900° C. Lower temperatures below 300° C. may serve to evaporate residual solvents from the battery electrolyte, at higher temperatures the binder polymers may decompose while at temperatures above 400° C. the composition of the inorganic materials may change as some transition metal oxides may become reduced either by the carbon contained in the scarp material or by introducing reductive gases. In some embodiments, a reduction of lithium metal oxides may be avoided by keeping the temperature below 400° C. and/or by removing carbonaceous materials before the heat treatment.

In some embodiments, the battery material comprises at least one chosen from lithiated nickel cobalt manganese oxide, lithiated nickel cobalt aluminum oxide, lithium metal phosphate, lithium ion battery scrap, black mass derived from a lithium ion battery, and combinations there.

In some embodiments, the battery material comprises lithium metal phosphate of formula LiₓMPO₄, wherein x is an integer greater than or equal to one, and M is chosen from metals, transition metals, rare earth metals, and combinations thereof.

In some embodiments, the battery material comprises lithiated nickel cobalt manganese oxide of formula Li₁₊ₓ(NiₐCO_{b}Mn_{c}M1_{d})₁₋ₓO₂, wherein M1 is chosen from Mg, Ca, Ba, Al, Ti, Zr, Zn, Mo, V and Fe, zero ≤x≤0.2, 0.1≤a≤0.95, zero ≤b≤0.9 (such as 0.05<b≤0.5), zero ≤c≤0.6, zero ≤d≤0.1, and a+b +c+d=1. Exemplary lithiated nickel cobalt manganese oxides include Li₍₁₊ₓ₎[Ni_{0.33}Co_{0.33}Mn_{0.33}]₍₁₋ₓ₎O₂, Li₍₁₊ₓ₎[Ni_{0.5}Co_{0.2}Mn_{0.3}]₍₁₋ₓ₎O₂, Li₍₁₊ₓ₎[Ni_{0.6}Co_{0.2}Mn_{0.2}]₍₁₋ₓ₎O₂, Li₍₁₊ₓ₎[Ni_{0.7}Co_{0.2}Mn_{0.3](1-x)}O₂, Li₍₁₊ₓ₎[Ni_{0.8}Co_{0.1}Mn_{0.1](1-x)}O₂ each with x as defined above, and Li[Ni_{0.85}Co_{0.13}Al_{0.02}]O₂.

In some embodiments, the battery material comprises lithiated nickel-cobalt aluminum oxides of formula Li[NiₕCoᵢAlⱼ]O₂₊ᵣ, wherein h ranges from 0.8 to 0.90,i ranges from 0.1 to 0.3, j ranges from 0.01 to 0.10, and r ranges from zero to 0.4

In some embodiments, the battery material comprises nickel, cobalt, manganese, copper, aluminum, iron, phosphorus, or combinations thereof.

In some embodiments, the battery material has a weight ratio ranging from 0.01to 100 of lithium to a total weight of nickel, cobalt, manganese, copper, aluminum, iron, and phosphorus. In some embodiments, wherein the battery material has a weight ratio ranging from 0.01 to 10 of lithium to a total weight of nickel, cobalt, manganese, copper, aluminum, iron, and phosphorus. In some embodiments, wherein the battery material has a weight ratio ranging from 0.01to 5 of lithium to a total weight of nickel, cobalt, manganese, copper, aluminum, iron, and phosphorus. In some embodiments, wherein the battery material has a weight ratio ranging from 0.01 to 2 of lithium to a total weight of nickel, cobalt, manganese, copper, aluminum, iron, and phosphorus. In some embodiments, wherein the battery material has a weight ratio ranging from 0.01 to 1 of lithium to a total weight of nickel, cobalt, manganese, copper, aluminum, iron, and phosphorus.

In some embodiments, the battery material comprises LiₓMO₂ wherein x is an integer greater than or equal to one, and M is chosen from metals, transition metals, rare earth metals, and combinations thereof.

In some embodiments, a process for recycling lithium ion battery materials comprises mechanically comminuting at least one chosen from a lithium ion battery, lithium ion battery waste, lithium ion battery production scrap, lithium ion cell production scrap, lithium ion cathode active material, and combinations thereof to obtain a black mass.

### Additional Embodiments

Without limitation, some embodiments of the disclosure include:
1. A process comprising: electrolyzing an aqueous solution comprising lithium, wherein the aqueous solution has a pH less than 0.5.
2. The process according to embodiment 1, wherein the aqueous solution comprises sulfate.
3. The process according to embodiment 1 or 2, wherein the pH of the aqueous solution is adjusted along a gradient ranging from −1 to 0.5.
4. The process according to embodiment 3, wherein the pH of the aqueous solution is adjusted up along a gradient ranging from −1 to 0.5.
5. The process according to embodiment 3, wherein the pH of the aqueous solution is adjusted down along a gradient ranging from −1 to 0.5.
6. A processes comprising: electrolyzing a first aqueous solution comprising lithium to obtain a second aqueous solution comprising lithium, and an acidic aqueous solution having a pH less than 0.5, adjusting the pH of the second aqueous solution with the acidic aqueous solution to obtain a third aqueous solution comprising lithium having a pH less than 0.5, and electrolyzing the third aqueous solution comprising lithium by the process according to any one of embodiments 1 to 5.
7. The process according to embodiment 6, wherein the first aqueous solution has a pH greater than 0.5.
8. The process according to embodiment 6 or 7, wherein electrolyzing the first aqueous solution is performed in a different electrolysis cell than electrolyzing the third aqueous solution.
9. A process comprising: stripping a liquid medium comprising lithium with an acidic aqueous solution to obtain an aqueous solution comprising lithium, and electrolyzing the aqueous solution comprising lithium by the process according to any one of embodiments 1 to 8 to obtain a lithium-depleted aqueous solution; wherein the lithium-depleted aqueous solution is provided upstream in the process as the acidic aqueous solution, wherein the liquid medium comprises less than 50 weight % water by total weight of the liquid medium, and wherein the lithium-depleted aqueous solution has a lower concentration of lithium than the aqueous solution comprising lithium.
10. The process according to embodiment 9, wherein the lithium-depleted aqueous solution has a concentration of lithium greater than zero.
11. The process according to embodiment 9 or 10, wherein the liquid medium comprises less than 5 weight % of water by total weight of the liquid medium.
12. The process according to embodiment 9, wherein the lithium-depleted aqueous solution has a concentration of lithium ranging from about 20 g/L to about 100 g/L.
13. The process according to embodiment 9, wherein the aqueous solution comprising lithium has a concentration of lithium ranging from about 20 g/L to about 100 g/L.
14. A process for preparing a liquid medium comprising lithium, wherein the process comprises: electrolyzing an aqueous solution comprising lithium by the process according to any one of embodiments 1 to 8 to obtain a lithium-depleted aqueous solution, and extracting the lithium-depleted aqueous solution with a liquid medium; wherein the liquid medium comprises less than 50 weight % of water by total weight of the liquid medium, and wherein the lithium-depleted aqueous solution has a lower concentration of lithium than the aqueous solution comprising lithium.
15. The process according to any one of embodiments 9 to 13, wherein the liquid medium comprising lithium is prepared according to the process of claim 14.
16. The process according to any one of embodiments 1 to 15, wherein electrolyzing an aqueous solution comprising lithium, wherein the aqueous solution has a pH less than 0.5, has a current density ranging from 0.1 A/cm² to 1.5 A/cm².
17. The process according to any one of embodiments 1 to 16, wherein electrolyzing an aqueous solution comprising lithium, wherein the aqueous solution has a pH less than 0.5, has a current density ranging from 0.1 A/cm² to 1 A/cm².
18. The process according to any one of embodiments 1 to 17, wherein electrolyzing an aqueous solution comprising lithium, wherein the aqueous solution has a pH less than 0.5, has a current density ranging from 0.3 A/cm² to 1 A/cm².
19. The process according to any one of embodiments 1 to 18, wherein electrolyzing an aqueous solution comprising lithium, wherein the aqueous solution has a pH less than 0.5, has a current density ranging from 0.4 A/cm² to 0.9 A/cm².
20. The process according to any one of embodiments 1 to 19, wherein electrolyzing an aqueous solution comprising lithium, wherein the aqueous solution has a pH less than 0.5, has a voltage ranging from 0 V to 5 V.
21. The process according to any one of embodiments 1 to 20, wherein electrolyzing an aqueous solution comprising lithium, wherein the aqueous solution has a pH less than 0.5, has a voltage ranging from 0 V to 3.5 V.
22. The process according to any one of embodiments 1 to 21, wherein electrolyzing an aqueous solution comprising lithium, wherein the aqueous solution has a pH less than 0.5, has a temperature ranging from 20° C. to 95° C.
23. The process according to any one of embodiments 1 to 22, wherein electrolyzing an aqueous solution comprising lithium, wherein the aqueous solution has a pH less than 0.5, has a temperature ranging from 30° C. to 90° C.
24. The process according to any one of embodiments 1 to 23, wherein electrolyzing an aqueous solution comprising lithium, wherein the aqueous solution has a pH less than 0.5, has a temperature ranging from 40° C. to 85° C.
25. The process according to any one of embodiments 1 to 24, wherein electrolyzing an aqueous solution comprising lithium, wherein the aqueous solution has a pH less than 0.5, has a temperature ranging from 50° C. to 85° C.
26. The process according to any one of embodiments 1 to 25, wherein a base is not added to the aqueous solution comprising lithium.
27. The process according to any one of embodiments 1 to 26, wherein the pH of the aqueous solution comprising lithium is not adjusted up.
28. A process for recycling lithium ion battery materials comprising: mechanically comminuting at least one chosen from a lithium ion battery, lithium ion battery waste, lithium ion battery production scrap, lithium ion cell production scrap, lithium ion cathode active material, and combinations thereof to obtain a black mass, leaching the black mass to obtain an aqueous solution comprising lithium, and processing the aqueous solution according to any one of embodiments 1 to 27.
29. The process according to any one of embodiments 6 to 8, wherein the first aqueous solution comprising lithium is obtained by a process comprising: mechanically comminuting at least one chosen from a lithium ion battery, lithium ion battery waste, lithium ion battery production scrap, lithium ion cell production scrap, lithium ion cathode active material, and combinations thereof to obtain a black mass, and leaching the black mass to obtain an aqueous solution comprising lithium.
30. The process according to any one of embodiments 1 to 27, wherein the aqueous solution comprising lithium is obtained by leaching a lithium containing ore.
31. The process according to any one of embodiments 1 to 27, wherein the aqueous solution comprising lithium is lithium containing ground water.
32. The process according to any one of embodiments 6 to 8, wherein the first aqueous solution comprising lithium is obtained by leaching a lithium containing ore.
33. The process according to any one of embodiments 6 to 8, wherein the first aqueous solution comprising lithium is lithium containing ground water.
34. The process according to any one of claims 1 to 27, wherein the aqueous solution comprising lithium is obtained by leaching a battery material.
35. The process according to any one of claims 6 to 8, wherein the first aqueous solution comprising lithium is obtained by leaching a battery material.

Claims or descriptions that include “or” or “and/or” between at least one members of a group are considered satisfied if one, more than one, or all of the group members are present in, employed in, or otherwise relevant to a given product or process unless indicated to the contrary or otherwise evident from the context. The disclosure includes embodiments in which exactly one member of the group is present in, employed in, or otherwise relevant to a given product or process. The disclosure includes embodiments in which more than one, or all the group members are present in, employed in, or otherwise relevant to a given product or process.

Furthermore, the disclosure encompasses all variations, combinations, and permutations in which at least one limitation, element, clause, and descriptive term from at least one of the listed claims is introduced into another claim. For example, any claim that is dependent on another claim can be modified to include at least one limitation found in any other claim that is dependent on the same base claim. Where elements are presented as lists, such as, e.g., in Markush group format, each subgroup of the elements is also disclosed, and any element(s) can be removed from the group. It should be understood that, in general, where the disclosure, or aspects of the disclosure, is/are referred to as comprising particular elements and/or features, embodiments of the disclosure or aspects of the disclosure consist, or consist essentially of, such elements and/or features. For purposes of simplicity, those embodiments have not been specifically set forth in haec verba herein. Where ranges are given, endpoints are included. Furthermore, unless otherwise indicated or otherwise evident from the context and understanding of one of ordinary skill in the art, values that are expressed as ranges can assume any specific value or sub range within the stated ranges in different embodiments of the disclosure, unless the context clearly dictates otherwise.

Those of ordinary skill in the art will recognize or be able to ascertain using no more than routine experimentation, many equivalents to the specific embodiments of the disclosure described herein. Such equivalents are intended to be encompassed by the following claims.

1. A process comprising electrolyzing an aqueous solution comprising lithium, wherein the aqueous solution has a pH less than 0.5.

2. The process according to claim 1, wherein the aqueous solution comprises sulfate.

3. The process according to claim 1, wherein the pH of the aqueous solution is adjusted along a gradient ranging from −1 to 0.5.

4. The process according to claim 3, wherein the pH of the aqueous solution is adjusted up along a gradient ranging from-1 to 0.5.

5. The process according to claim 3, wherein the pH of the aqueous solution is adjusted down along a gradient ranging from −1 to 0.5.

6. A process comprising electrolyzing a first aqueous solution comprising lithium to obtain a second aqueous solution comprising lithium, and an acidic aqueous solution having a pH less than 0.5, adjusting the pH of the second aqueous solution with the acidic aqueous solution to obtain a third aqueous solution comprising lithium having a pH less than 0.5, and electrolyzing the third aqueous solution comprising lithium by the process according to claim 1.

7. The process according to claim 6, wherein the first aqueous solution has a pH greater than 0.5.

8. The process according to claim 6, wherein electrolyzing the first aqueous solution is performed in a different electrolysis cell than electrolyzing the third aqueous solution.

9. A process comprising stripping a liquid medium comprising lithium with an acidic aqueous solution to obtain an aqueous solution comprising lithium, and electrolyzing the aqueous solution comprising lithium by the process according to claim 1 to obtain a lithium-depleted aqueous solution; wherein the lithium-depleted aqueous solution is provided upstream in the process as the acidic aqueous solution, wherein the liquid medium comprises less than 50 weight % water by total weight of the liquid medium, and wherein the lithium-depleted aqueous solution has a lower concentration of lithium than the aqueous solution comprising lithium.

10. The process according to claim 9, wherein the lithium-depleted aqueous solution has a concentration of lithium greater than zero.

11. The process according to claim 9, wherein the liquid medium comprises less than 5 weight % of water by total weight of the liquid medium.

12. The process according to claim 9, wherein the lithium-depleted aqueous solution has a concentration of lithium ranging from about 20 g/L to about 100 g/L.

13. The process according to claim 9, wherein the aqueous solution comprising lithium has a concentration of lithium ranging from about 20 g/L to about 100 g/L.

14. A process for preparing a liquid medium comprising lithium, wherein the process comprises electrolyzing an aqueous solution comprising lithium by the process according to claim 1 to obtain a lithium-depleted aqueous solution, and extracting the lithium-depleted aqueous solution with a liquid medium; wherein the liquid medium comprises less than 50 weight % of water by total weight of the liquid medium, and wherein the lithium-depleted aqueous solution has a lower concentration of lithium than the aqueous solution comprising lithium.

15. (canceled)

16. The process according to claim 1, wherein the aqueous solution comprising lithium has a pH less than 0.5 and is electrolyzed at a current density ranging from 0.1 A/cm2 to 1.5 A/cm2.

17. (canceled)

18. (canceled)

19. (canceled)

20. The process according to claim 1, wherein the aqueous solution comprising lithium has a pH less than 0.5 and is electrolyzed at a voltage ranging from 0 V to 5 V.

21. (canceled)

22. The process according to claim 1, wherein the aqueous solution comprising lithium has a pH less than 0.5 and a temperature ranging from 20°° C. to 95° C.

23. (canceled)

24. (canceled)

25. (canceled)

26. The process according to claim 15, wherein a base is not added to the aqueous solution comprising lithium.

27. The process according to claim 1, wherein the pH of the aqueous solution comprising lithium is not adjusted up.

28. A process for recycling lithium ion battery materials comprising mechanically comminuting at least one chosen from a lithium ion battery, lithium ion battery waste, lithium ion battery production scrap, lithium ion cell production scrap, lithium ion cathode active material, and combinations thereof to obtain a black mass, leaching the black mass to obtain an aqueous solution comprising lithium, and processing the aqueous solution according to claim 1.

29. (canceled)

30. The process according to claim 1, wherein the aqueous solution comprising lithium is obtained by leaching a lithium containing ore, lithium containing ground water, or battery material.

31. (canceled)

32. (canceled)

33. (canceled)

34. (canceled)

35. (canceled)
